(19) United States
(12) Patent Application Publication
(10) Pub. No.: US 2014/0203553 A1
(43) Pub. Date: Jul. 24, 2014

(54) Connector Assembly for Liquid Media Pipes

(71) Applicant: TUCAI, S.A., Barcelona (ES)

(72) Inventor: Daniel Granados Niubo, Barcelona (ES)

(73) Assignee: TUCAI, S.A., Barcelona (ES)

(21) Appl. No.: 14/156,627

(22) Filed: Jan. 16, 2014

(30) Foreign Application Priority Data
Jan. 22, 2013 (ES) 201330066

(51) Int. Cl. F16L 25/00

(52) U.S. Cl. CPC F16L 25/0036
USPC 285/354

(57) ABSTRACT

A connector assembly for liquid media pipes, particularly for joining fittings and/or parts of systems for transporting domestic liquid media or the like, comprising a corrugated pipe and at least one tubular head with a central through-hole, wherein the tubular head has a concentric tubular extension with the central through-hole, which is insertable into the inner contour of at least one of the ends of the corrugated pipe, said extension provided with a number of circumferential annular shoulders on its outer contour that are equipped to fit into the inner contour of the corrugated pipe, and the tubular extension having at least one knurled section on its outer surface that is in contact with the inner contour of the corrugated pipe in which said tubular extension is inserted.

### OBJECT OF THE INVENTION

The purpose of the application herein is to register a connector assembly for liquid media pipes, which incorporates significant innovations and advantages, when compared to techniques that have been used up to the present time.

More specifically, the invention proposes the development of a connector assembly for liquid media pipes, to ensure the connection for liquid media pipes to an added fitting or other mobile fittings, in a safe and reliable manner, for use with potable or domestic water or the like.

### BACKGROUND OF THE INVENTION

Different connectors intended for coupling to a corrugated pipe for installations through which domestic water or the like circulates are known in the current state of the art.

In this respect, inner couplings made of plastic and a braided sleeve are conventional and known, wherein at least one end of the coupling is provided with a connecting portion having a tubular connector, on which the end of the coupling is tightened from the outside by means of a press-fit bushing, in which the inner coupling is formed by a corrugated coupling which is corrugated in parallel, wherein the corrugated coupling is enclosed directly by the outer sleeve and wherein the tubular connector has annular ribs which extend in the periphery adapted to the inner contour of the corrugated pipe.

In other cases, even at least some of the annular ribs are provided with axially extending notches.

In the case of the annular ribs, fitting into the inner contour of the flexible pipe provides a resistance to different mechanical stresses, but very limited only in the case of stresses in an axial direction to prevent recoil, their effectiveness being reduced or eliminated in other spatial directions.

Such arrangements do not always ensure the maximum safety and adequate resistance to the different mechanical stresses that the connector could possibly experience, especially those that may occur in varied and different directions and spatial orientations, caused for example by pressure surge or fluid hammer, sudden changes in flow, temperature changes caused by hot liquids, manual handling etc., perfectly possible in installations transferring liquid media.

The present invention contributes to addressing and resolving these problems, as a connector assembly for liquid media pipes can be made in order to form a connection for liquid media pipes with an added fitting or other mobile fitting, providing proper and reliable security against possible and various stresses, especially in the case of application for uses of potable or domestic water or the like.

### DESCRIPTION OF THE INVENTION

The invention herein has been developed with the aim of providing a connector assembly for liquid media pipes that resolves the aforementioned drawbacks, providing, in addition, other additional advantages that will become apparent from the description appended hereinafter.

According to the subject matter of the invention, the connector assembly for liquid media pipes, particularly for joining fittings and/or parts of systems for transporting domestic liquid media or the like, is essentially characterised in that it comprises a corrugated pipe and at least one tubular head with a central through-hole, wherein the tubular head has a concentric tubular extension with the central through-hole, which is insertable into the inner contour of at least one of the ends of the corrugated pipe, said extension provided with a number of circumferential annular shoulders on its outer contour that are equipped to fit into the inner contour of the corrugated pipe, and the tubular extension having at least one knurled section on its outer surface that is in contact with the inner contour of the corrugated pipe into which said tubular extension is inserted.

Additionally, the corrugated pipe in the connector assembly for liquid media pipes is surrounded by a braided, metal or plastic tube.

Preferably, the tubular head in the connector assembly for liquid media pipes is made of metal material.

Alternatively, the tubular head in the connector assembly for liquid media pipes is made of plastic material.

Furthermore, the knurled section of the tubular extension in the connector assembly for liquid media pipes is made by a series of grooves or intersecting ridges following a certain pattern and worked on its outer surface.

Similarly, the knurled section in the connector assembly for liquid media pipes is positioned in the segment of the tubular extension between the annular shoulders and the body of the tubular head.

Furthermore, the connector assembly for liquid media pipes comprises a means for tightening the end of the corrugated pipe on the tubular extension inserted into said corrugated pipe.

In this regard, the tightening means in the connector assembly for liquid media pipes consists of a press-fit bushing, located outside the corrugated pipe, being concentric and tightened thereto, on the tubular extension inserted into said corrugated pipe.

Thanks to the invention herein, the necessary resistance to different and unexpected mechanical stresses caused by pressure surge or fluid hammer, sudden changes in flow, temperature changes caused by hot liquids, manual handling, etc. is provided to the hitherto known connections in liquid media circuits, such as in potable and domestic water.

Other characteristics and advantages of the connector assembly for liquid media pipes will become apparent from the description of a preferred, although not exclusive embodiment, that is illustrated by way of non-limiting example in the drawings appended, in which:

### BRIEF DESCRIPTION OF THE DRAWINGS

FIG. 1.—A representation of a loose corrugated pipe, an integral part of the invention herein.

FIG. 2.—Elevation view, with a partial section and in perspective, of the tubular head which is an integral part of the invention.

FIG. 3.—Schematic representation in a section of the tubular head inserted in the corrugated pipe.

FIG. 4.—Schematic representation of the tubular head inserted into the corrugated pipe.

FIG. 5.—Schematic representation of the invention herein, the corrugated pipe being surrounded by a braided, metal or plastic tube and with a press-fit bushing.

### DESCRIPTION OF A PREFERRED EMBODIMENT

As shown in the figures, the connector assembly for liquid media pipes, particularly for joining fittings and/or parts of systems for transporting domestic liquid media or the like, is characterised in that it essentially comprises a corrugated pipe 1 and at least one tubular head 2 with a central through-hole 3, wherein the tubular head 2 has a concentric tubular extension 4 with the central through-hole, which is insertable into and can be adjusted in the inner contour of at least one of the ends 11 of the corrugated pipe 1, and is provided with a number of circumferential annular shoulders 5 on its outer contour that are equipped to fit into the inner contour of the corrugated pipe 1, and the tubular extension 4 having at least one knurled section 6 that is in contact with the inner contour of the corrugated pipe 1 into which said tubular extension 4 is inserted.

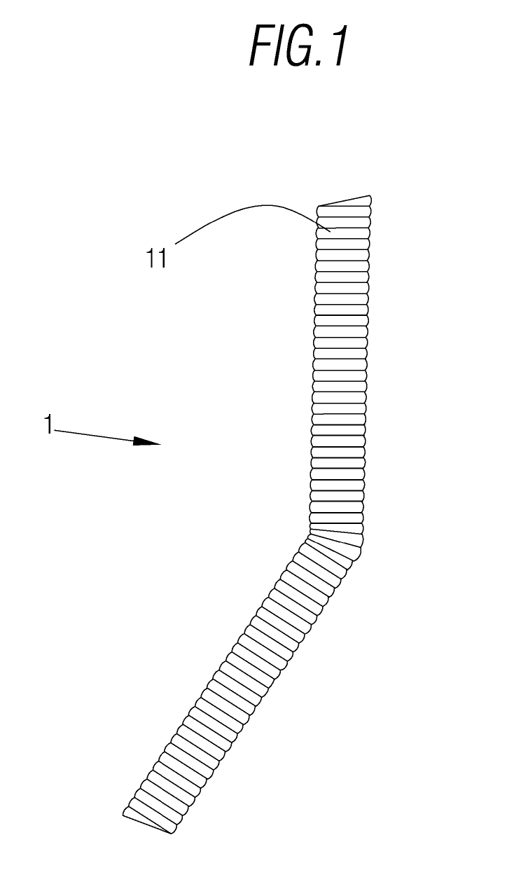

As seen in FIG. 1, the corrugated pipe 1 is made of flexible plastic material, its inner and outer contour having a corrugated profile for this purpose.

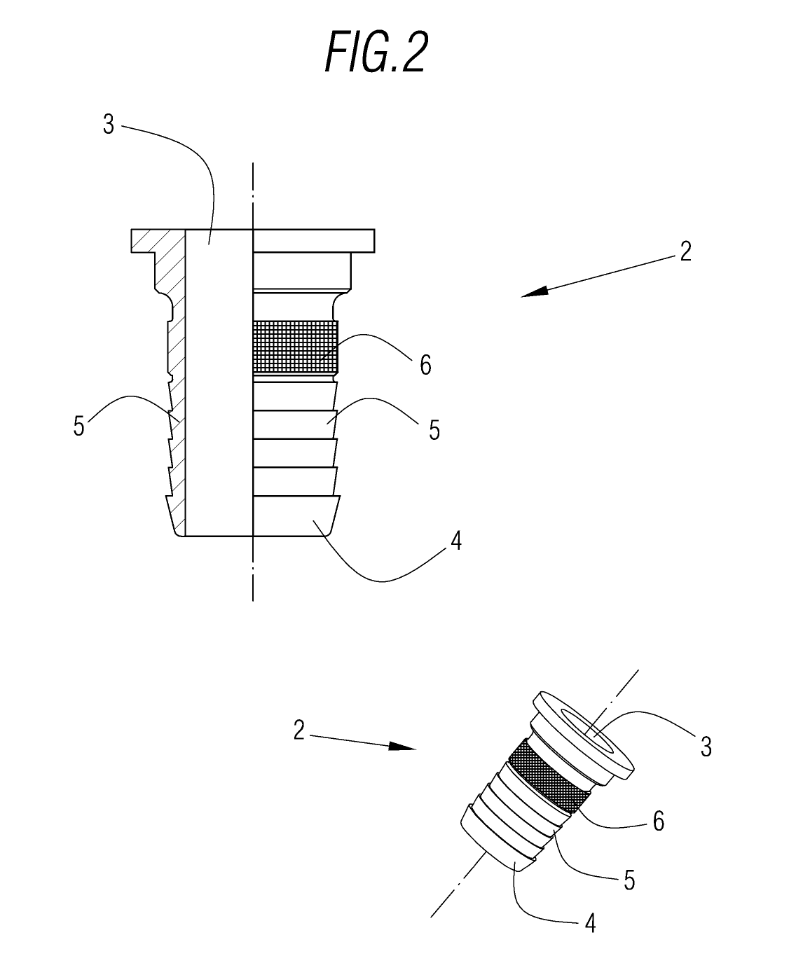

FIG. 2 shows the tubular head 2, in an elevation view with a partial section and in perspective, which in this form of preferred embodiment is made of metal material, although in other forms of embodiment it can be made of materials with a suitable rigidity, such as plastic.

As can be seen, it has a central through-hole 3 and a concentric tubular extension 4 with the centre hole 3 and which is adapted in its proportions and appearance for insertion into one end 11 in the inner contour of the corrugated pipe 1.

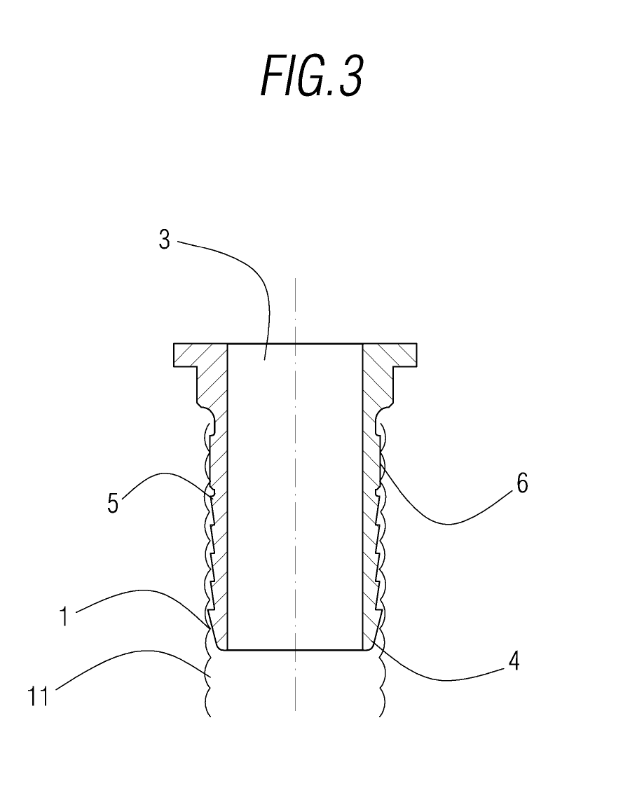

As can be seen in FIGS. 2 and 3, the tubular extension 4 is provided with a number of circumferential annular shoulders 5 on its outer contour, that are equipped to fit into the inner contour of the profile of the corrugated pipe 1.

In addition to the annular ribs 5 explained above, the tubular extension 4 has a knurled section 6 on its outer contour below the annular shoulders 5, and is therefore in contact with the inner contour of the corrugated pipe 1.

There are different types of knurling that may be suitable for the invention herein, such as the knurling commonly known as crossed, in an X or in diagonal, and that this form of preferred embodiment is suitably adapted to the needs the invention herein addresses.

In the case of the annular shoulders 5, fitting into the inner contour of the corrugated pipe 1 provides a resistance to different mechanical stresses, but very limited only in the case of stresses in an axial direction to prevent recoil, their effectiveness for stresses being reduced or eliminated in other spatial directions.

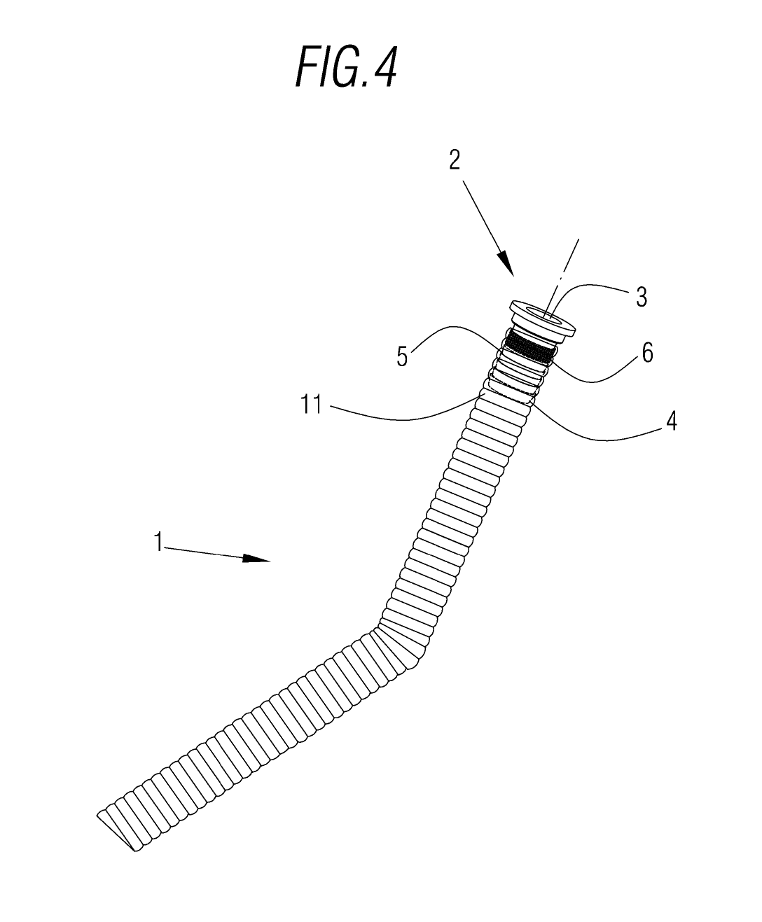

Once inserted into the inner contour of the corrugated pipe 1 (as shown schematically in FIG. 4), the knurled section 6 in the tubular extension 4 provides the tubular head 2 with greater ability to grip in relation to the inner contour of the corrugated pipe 1 into which it is inserted, against different and unexpected mechanical stresses which it may be potentially subjected to, without moving in its inserted position in relation to the inner contour of the corrugated pipe 1 and even in the event of getting wet.

Such gripping ability is particularly significant in the case of stresses occurring in different and unexpected directions in the three isometric spatial directions, for which the special and characteristic texture of the knurled section 6 may offer such resistance in any of the directions and spatial orientations where such stress may occur, such as torsional, radial, axial forces, etc. or various combinations thereof.

The corrugated pipe 1 may be surrounded by a braided tube 7, and further be provided with a tightening means in order to ensure tightness and effective insertion of the tubular extension 4 inside the end 11 of the corrugated pipe 1, in the furthermost position and wherein the knurled section 6 is.

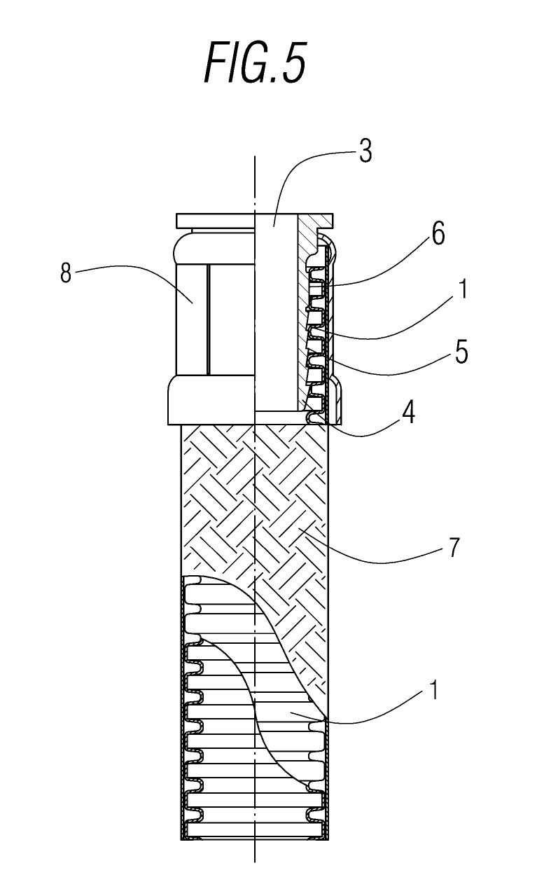

As shown schematically in FIG. 5, in this form of preferred embodiment, the tightening means consists of a press-fit bushing 8, located outside the corrugated pipe 1, and concentric and tightened thereto, on the tubular extension 4 inserted into said corrugated pipe 1.

Thanks to the invention herein, the necessary resistance to different and unexpected mechanical stresses in many and various spatial orientations caused by pressure surge or fluid hammer, sudden changes in flow, temperature changes caused by hot liquids, manual handling, connection and disconnection of fittings and/or mobile systems, etc. is provided to the hitherto known joints in the liquid media circuits, such as in potable and domestic water.

Such situations are perfectly possible in installations transferring liquid media, and for example during routine maintenance.

The details, shapes, dimensions and other accessory elements, as well as the materials used in the manufacture of the connector assembly for liquid media pipes of the invention may be conveniently replaced by others which are technically equivalent and do not depart from the essential nature of the invention or from the scope defined by the claims appended hereinafter.

1. A connector assembly for liquid media pipes, particularly for joining fittings and/or parts of systems for transporting domestic liquid media or the like, comprising a corrugated pipe and at least one tubular head with a central through-hole, wherein the tubular head has a concentric tubular extension with the central through-hole, which is insertable into the inner contour of at least one of the ends of the corrugated pipe, said extension provided with a number of circumferential annular shoulders on its outer contour that are equipped to fit into the inner contour of the corrugated pipe, and the tubular extension having at least one knurled section on its outer surface that is in contact with the inner contour of the corrugated pipe into which said tubular extension is inserted.

2. A connector assembly for liquid media pipes according to claim 1, wherein the corrugated pipe is surrounded by a braided, metal or plastic tube.

3. A connector assembly for liquid media pipes according to claim 1, wherein the tubular head is made of metal material.

4. A connector assembly for liquid media pipes according to claim 1, wherein the tubular head is made of plastic material.

5. A connector assembly for liquid media pipes according to claim 1, wherein the knurled section of the tubular extension is made by a series of grooves or intersecting ridges following a certain pattern and worked on its outer surface.

6. A connector assembly for liquid media pipes according to claim 1, wherein the knurled section is positioned in the segment of the tubular extension between the annular shoulders and the body of the tubular head.

7. A connector assembly for liquid media pipes according to claim 1, comprising a means for tightening the end of the corrugated pipe (1) on the tubular extension inserted into said corrugated pipe.

8. A connector assembly for liquid media pipes according to claim 7 wherein the tightening means consists of a press-fit bushing, located outside the corrugated pipe, and concentric and tightened thereto, on the tubular extension inserted into said corrugated pipe.
